(19) United States
(12) Patent Application Publication
(10) Pub. No.: US 2023/0069354 A1
(43) Pub. Date: Mar. 2, 2023

(54) ELECTRO-OPTICAL DEVICE AND ELECTRONIC APPARATUS

(71) Applicant: SEIKO EPSON CORPORATION, Tokyo (JP)

(72) Inventor: Shuji TERADA, MATSUMOTO-SHI (JP)

(73) Assignee: SEIKO EPSON CORPORATION, Tokyo (JP)

(21) Appl. No.: 17/898,445

(22) Filed: Aug. 29, 2022

(30) Foreign Application Priority Data
Aug. 31, 2021 (JP) 2021-141022

(51) Int. Cl. G02F 1/1362; G01K 7/01; G02F 1/1333

(52) U.S. Cl. CPC G02F 1/136286; G01K 7/01; G02F 1/133388; G02F 1/136254; G02F 1/136209

(57) ABSTRACT

In an electro-optical device, in a first substrate, a scanning line driving circuit is provided along a first side extending in a first direction, and a temperature-detecting element is provided in a second direction relative to the scanning line driving circuit. Accordingly, the temperature-detecting element and wiring (first wiring and second wiring) electrically connected to the temperature-detecting element can be separated from the scanning lines. In the temperature-detecting element, a plurality of diodes including a semiconductor layer are disposed in a second direction. The dimension in the first direction of the temperature-detecting element is smaller than the dimension in the first direction of a wiring region between the scanning line driving circuit and a display region.

The present application is based on, and claims priority from JP Application Serial Number 2021-141022, filed Aug. 31, 2021, the disclosure of which is hereby incorporated by reference herein in its entirety.

### BACKGROUND

### 1. Technical Field

The present disclosure relates to an electro-optical device provided with a temperature-detecting element, and an electronic apparatus.

### 2. Related Art

There has been proposed a technology of providing a temperature-detecting element outside the display region in electro-optical devices such as liquid crystal devices, and correcting or otherwise modifying driving conditions based on detection results of the temperature-detecting element (see JP-A-2018-194666). In JP-A-2018-194666, diodes constituting the temperature-detecting element are disposed between the display region and a scanning line driving circuit.

However, scanning lines extend between the display region and the scanning line driving circuit, and thus when the temperature-detecting element is disposed between the display region and the scanning line driving circuit, scanning signals supplied to the scanning lines affect the temperature-detecting element, causing the detection accuracy to decrease.

### SUMMARY

In order to solve the problems described above, an aspect of an electro-optical device according to the present disclosure includes: a scanning line driving circuit disposed along a first direction, and a temperature-detecting element disposed in the first direction relative to the scanning line driving circuit, wherein the temperature-detecting element includes a plurality of semiconductor layers provided aligned in a constant direction.

The electro-optical device according to the present disclosure is used in electronic apparatuses.

### BRIEF DESCRIPTION OF THE DRAWINGS

FIG. 1 is a plan view illustrating a configuration example of an electro-optical device according to Embodiment 1 of the present disclosure.

FIG. 2 is an explanatory view schematically illustrating a cross section of the electro-optical device illustrated in FIG. 1.

FIG. 3 is a circuit block diagram illustrating the electrical configuration of a first substrate and the like illustrated in FIG. 1.

FIG. 4 is an explanatory view of a temperature-detecting circuit illustrated in FIG. 3.

FIG. 5 is an explanatory view illustrating a planar configuration of the temperature-detecting circuit and the like illustrated in FIG. 4.

FIG. 6 is a plan view schematically illustrating a planar configuration of the temperature-detecting element illustrated in FIG. 5.

FIG. 7 is a cross-sectional view schematically illustrating a cross section of the temperature-detecting element illustrated in FIG. 6.

FIG. 8 is a plan view schematically illustrating another planar configuration of the temperature-detecting element illustrated in FIG. 5.

FIG. 9 is a cross-sectional view schematically illustrating a cross section of the temperature-detecting element illustrated in FIG. 8.

FIG. 10 is a graph showing an example of the relationship between the driving current and the impact of noise.

FIG. 11 is an explanatory view of an electro-optical device according to Embodiment 2 of the present disclosure.

FIG. 12 is a block diagram illustrating a configuration example of a projection-type display device to which the present disclosure is applied.

FIG. 13 is an explanatory view of an optical path-shifting element illustrated in FIG. 12.

### DESCRIPTION OF EXEMPLARY EMBODIMENTS

Embodiments of the present disclosure will now be described with reference to the accompanying drawings. Note that in each of the figures referred to in the following description, to illustrate each layer, each member, and the like in a recognizable size in the drawings, each layer, each member, and the like are illustrated at a different scale. Furthermore, a plan view means a state viewed from a normal direction relative to a first substrate 10 or a second substrate 20. Furthermore, in the description, of the two directions intersecting each other in an in-plane direction of the first substrate 10, one is referred to as the first direction Y, and the other is referred to as the second direction X.

### 1. Embodiments

### 1-1. Overall Configuration of Electro-Optical Device 100

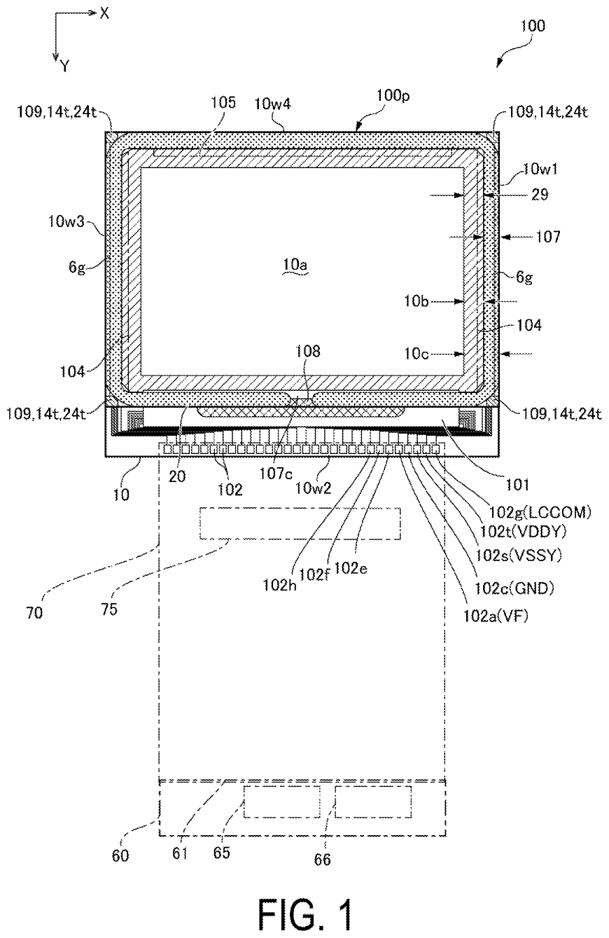

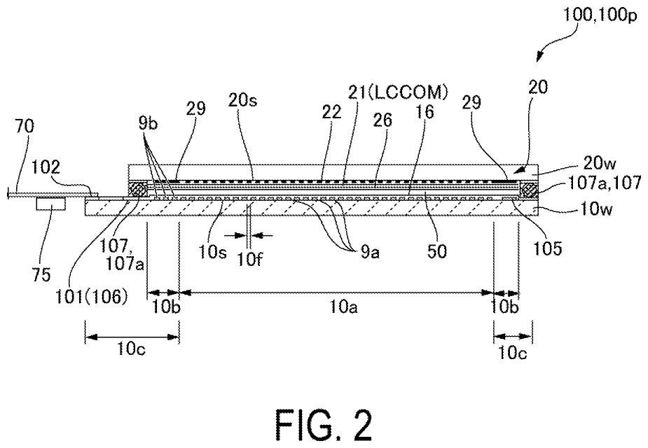

FIG. 1 is a plan view illustrating a configuration example of an electro-optical device 100 according to Embodiment 1 of the present disclosure. FIG. 2 is an explanatory view schematically illustrating a cross section of the electro-optical device 100 illustrated in FIG. 1. The electro-optical device 100 illustrated in FIGS. 1 and 2 is a liquid crystal device, and includes an electro-optical panel 100p. In the electro-optical device 100, the first substrate 10 and the second substrate 20 are bonded together by a seal material 107 via a predetermined gap between the first substrate 10 and the second substrate 20. The seal material 107 is provided in a frame shape along the outer edge of the second substrate 20. The seal material 107 is an adhesive containing a photocurable resin, a thermosetting resin, or the like. A gap material 107a such as glass fiber or glass beads is blended in the seal material 107 to bring the distance between the first substrate 10 and the second substrate 20 to a predetermined value. In the electro-optical device 100, an electro-optical layer 50 including a liquid crystal layer is provided inside a region surrounded by the seal material 107 in the space between the first substrate 10 and the second substrate 20. In the seal material 107, a cut portion 107c used as a liquid crystal injection port is formed. After a liquid crystal material is injected, such a cut portion 107c is plugged by an encapsulant 108. Note that when the liquid crystal material is filled by a dripping method, the cut portion 107c is not formed. The first substrate 10 and the second substrate 20 are both a quadrangle. In a substantially central portion of the electro-optical device 100, a display region 10a is provided as a quadrangular region. To match such a shape, the seal material 107 is also provided in a substantially quadrangular shape. An outer peripheral region 10c having a quadrangular frame shape is provided outside the display region 10a.

In the following description, in the first substrate 10, a side extending in the first direction Y is referred to as the first side 10w1, and a side adjacent to the first side 10w1 and extending in the second direction X is referred to as the second side 10w2. Furthermore, in the first substrate 10, a side extending in the first direction Y so as to face the first side 10w1 in the second direction X is referred to as the third side 10w3, and a side extending in the second direction X so as to face the second side 10w2 in the first direction Y is referred to as the fourth side 10w4.

In the outer peripheral region 10c of the first substrate 10, a scanning line driving circuit 104 is provided between the first side 10w1 of the first substrate 10 and the display region 10a, and between the third side 10w3 of the first substrate 10 and the display region 10a, respectively. Furthermore, a data line driving circuit 101 is provided between the second side 10w2 of the first substrate 10 and the display region 10a, and an inspection circuit 105 is provided between the fourth side 10w4 of the first substrate 10 and a second side 10a2 of the display region 10a. In the first substrate 10, between the second side 10w2 and the data line driving circuit 101, a plurality of mounting terminals 102 are arranged along the second side 10w2. A wiring substrate 70 is connected to the terminals 102. A driving integrated circuit (IC) 75 that outputs an image signal VID or the like to the electro-optical panel 100p is mounted on the wiring substrate 70. The wiring substrate 70 is electrically connected to an upper circuit 60 via a connector 61. The upper circuit 60 is provided with an image control circuit 65 that outputs image data or the like to the driving IC 75. The upper circuit 60 is also provided with a temperature detection driving circuit 66 that drives a temperature-detecting circuit 1 to be described later. The upper circuit 60 is provided in an upper device of the electro-optical device 100 in an electronic apparatus to be described later.

The first substrate 10 includes a light-transmitting substrate main body 10w such as a quartz substrate or a glass substrate. On the side of a first surface 10s facing the second substrate 20 of the first substrate 10, a plurality of pixel transistors and pixel electrodes 9a are formed in a matrix pattern in the display region 10a. The pixel electrodes 9a are each electrically connected to a corresponding pixel transistor among the plurality of pixel transistors. A first oriented film 16 is formed on the upper layer side of the pixel electrodes 9a. On the first surface 10s side of the first substrate 10, in a quadrangle frame-shaped region 10b extending between the outer edge of the display region 10a and the seal material 107, dummy pixel electrodes 9b formed simultaneously with the pixel electrodes 9a are formed in a portion extending along the sides of the display region 10a.

The second substrate 20 includes a light-transmitting substrate main body 20w such as a quartz substrate or a glass substrate. On the side of a first surface 20s facing the first substrate 10 of the second substrate 20, a common electrode 21 is formed. A second oriented film 26 is stacked on the surface of the common electrode 21. The common electrode 21 is formed substantially across the entire surface on the first surface 20s side of the second substrate 20. In the frame-shaped region 10b on the first surface 20s side of the second substrate 20, a display end light-blocking region 29 including a light-blocking layer is formed on the lower layer side of the common electrode 21. The inner edge of the display end light-blocking region 29 defines the display region 10a. A light-transmitting flattening film 22 is formed between the display end light-blocking region 29 and the common electrode 21. The light-blocking layer constituting the display end light-blocking region 29 may be formed as a black matrix portion overlapping, in plan view, inter-pixel regions 10f sandwiched between adjacent pixel electrodes 9a. The display end light-blocking region 29 overlaps the dummy pixel electrodes 9b in plan view. The display end light-blocking region 29 is constituted by a light-blocking metal film or black resin.

The first oriented film 16 and the second oriented film 26 are each an inorganic oriented film including a diagonally vapor-deposited film of SiOₓ (x≤2), TiO₂, MgO, Al₂O₃, or the like, and each includes a columnar structure layer in which columnar bodies, referred to as columns, are formed oblique to the first substrate 10 and the second substrate 20. Accordingly, the first oriented film 16 and the second oriented film 26 cause nematic liquid crystal molecules that are used in the electro-optical layer 50 and that have negative dielectric anisotropy to be oriented in an inclined manner oblique to the first substrate 10 and the second substrate 20, thereby causing the liquid crystal molecules to be pre-tilted. In this way, the electro-optical device 100 is constituted as a liquid crystal device of a normally black vertical alignment (VA) mode.

Outside the seal material 107 in the first substrate 10, inter-substrate conduction electrodes 14t are formed in positions overlapping four corner portions 24t of the second substrate 20. The inter-substrate conduction electrodes 14t are conductively connected to common potential wiring 6g. The common potential wiring 6g is conductively connected, of the terminals 102, to a common potential application terminal 102g. An inter-substrate conduction material 109 including conductive particles is disposed between the inter-substrate conduction electrodes 14t and the common electrode 21. The common electrode 21 of the second substrate 20 is electrically connected to the first substrate 10 side via the inter-substrate conduction electrodes 14t and the inter-substrate conduction material 109. Consequently, a common potential LCCOM is applied to the common electrode 21 from the first substrate 10 side.

The electro-optical device 100 of the present embodiment is a transmission-type liquid crystal device. Accordingly, the pixel electrodes 9a and the common electrode 21 are each formed of a light-transmitting conductive film such as an indium tin oxide (ITO) film and an indium zinc oxide (IZO) film. In such a transmission-type liquid crystal device, a light source light incident from the second substrate 20 side is modulated, before being emitted from the first substrate 10, to display an image.

### 1-2. Electrical Configuration of Electro-Optical Device 100

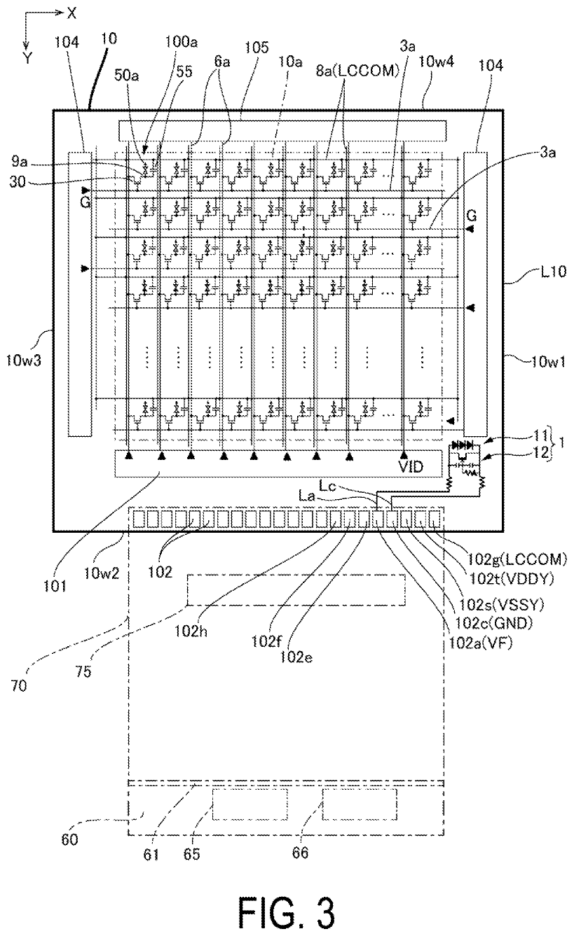

FIG. 3 is a circuit block diagram illustrating the electrical configuration of the first substrate 10 and the like illustrated in FIG. 1. As illustrated in FIG. 3, in the electro-optical device 100, the first substrate 10 used in the electro-optical panel 100 includes, in a central region thereof, the display region 10a in which a plurality of pixel circuits 100a are arranged in a matrix pattern. Inside the display region 10a, a plurality of scanning lines 3a extending in the second direction X from the scanning line driving circuit 104, and a plurality of data lines 6a extending in the first direction Y from the data line driving circuit 101 are provided. The pixel circuits 100a are formed corresponding to the intersections between the scanning lines 3a and the data lines 6a. The plurality of data lines 6a are electrically connected to the inspection circuit 105. The inspection circuit 105 is a transistor array, in which one of the sources/drains of the transistors are electrically connected to the data lines 6a, the other of the sources/drains are electrically connected to an inspection line (not illustrated), and the gates are electrically connected to control signal wiring.

In each of the plurality of pixel circuits 100a, a pixel transistor 30 including a field effect transistor or the like, and a pixel electrode 9a electrically connected to the pixel transistor 30 are provided. A data line 6a is electrically connected to the source of the pixel transistor 30. A scanning line 3a is electrically connected to the gate of the pixel transistor 30. The pixel electrode 9a is electrically connected to the drain of the pixel transistor 30. Image signals are supplied to the data line 6a. Scanning signals are supplied to the scanning line 3a.

In each of the pixel circuits 100a, the pixel electrode 9a faces the common electrode 21 of the second substrate 20 described above with reference to FIG. 2 via the electro-optical layer 50 to constitute a liquid crystal capacitor 50a. A retention capacitor 55 disposed in parallel with the liquid crystal capacitor 50a is added to each of the pixel circuits 100a to prevent fluctuation of the image signal retained by the liquid crystal capacitor 50a. In the present embodiment, capacitance lines 8a extending across the plurality of pixel circuits 100a are formed in the first substrate 10 to constitute retention capacitors 55. The common potential LCCOM is supplied to the capacitance lines 8a. The capacitance lines 8a are provided so as to overlap at least one of the scanning lines 3a and the data lines 6a. FIG. 3 illustrates an aspect in which the capacitance lines 8a overlap both the scanning lines 3a and the data lines 6a. Although not illustrated, the capacitance lines 8a are electrically connected to the common potential wiring 6g illustrated in FIG. 1.

In the first substrate 10, the temperature-detecting circuit 1 is formed outside the display region 10a. Accordingly, the plurality of terminals 102 include a first terminal 102a and a second terminal 102c electrically connected to the temperature-detecting circuit 1.

Furthermore, in the plurality of terminals 102, for example, terminals 102g, 102t, 102s, a first terminal 102a, a second terminal 102c, and terminals 102e, 102f, and 102h are arranged in this order from the first side 10w1 side toward the third side 10w3 side of the first substrate 10. The terminal 102g is a terminal 102 for supplying the common potential LCCOM. The terminal 102t is a terminal for supplying a high level constant potential VDDY to the scanning line driving circuit 104. The terminal 102s is a terminal for supplying a low level constant potential VSSY to the scanning line driving circuit 104. The terminals 102e and 102f are inspection terminals. The terminal 102h is a terminal for applying a constant potential to the dummy pixel electrodes 9b.

### 1-3. Configuration of Temperature-Detecting Circuit 1 and the Like

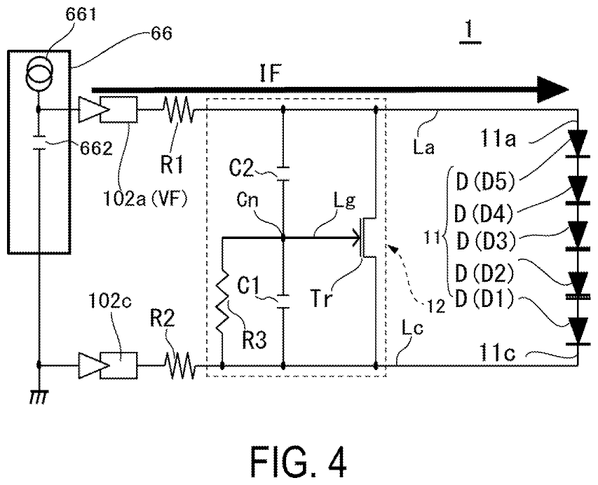

FIG. 4 is an explanatory view of the temperature-detecting circuit 1 illustrated in FIG. 3. As illustrated in FIG. 4, the temperature-detecting circuit 1 includes the temperature-detecting element 11. The temperature-detecting element 11 includes, for example, a plurality of diodes D connected in series to each other. FIG. 4 illustrates an embodiment in which five diodes D are electrically connected in series to each other. Hereinafter, the five diodes D will be each referred to as the first diode D1, the second diode D2, the third diode D3, the fourth diode D4, and the fifth diode D5. First wiring La extending from the first terminal 102a is electrically connected to the anode 11a of the first diode D1 of the temperature-detecting element 11. Second wiring Lc extending from the second terminal 102c is electrically connected to the cathode 11c of the fifth diode D5 of the temperature-detecting element 11.

Accordingly, when a temperature is detected with the electro-optical device 100 installed in the electronic apparatus, a minute forward driving current IF of approximately 10 nA to a few μA is supplied from the temperature detection driving circuit 66 via the wiring substrate 70 connected to the first substrate 10, and to the five temperature-detecting elements 11 of the temperature-detecting circuit 1 via the first terminal 102a and the second terminal 102c. Here, the forward voltage of the temperature-detecting element 11 varies with an almost linear characteristic relative to the temperature. Consequently, when the voltage between the first terminal 102a and the second terminal 102c is detected, the temperature of the electro-optical panel 100p can be detected. At this time, the temperature-detecting element 11 is disposed in the vicinity of the display region 10a, and thus the temperature-detecting element 11 can appropriately detect the temperature of the display region 10a. Therefore, if the image signal is corrected or otherwise modified based on the temperature detected by the temperature-detecting circuit 1, the electro-optical device 100 can be driven under appropriate conditions corresponding to the temperature of the display region 10a, and thus a high quality image can be displayed.

Note that the temperature detection driving circuit 66 includes a constant current circuit 661, and a stabilizing capacitor 662 between the constant current circuit 661 and the ground. The stabilizing capacitor 662 is electrically connected to wiring electrically connected to the first terminal 102a, and wiring electrically connected to the second terminal 102c. The stabilizing capacitor 662 stabilizes measured values of the output voltage VF. The capacitance of the stabilizing capacitor 662 is, for example, 0.1 μF.

In the temperature-detecting circuit 1, the first resistor unit R1 and the second resistor unit R2 are provided as protective resistance in the first wiring La and the second wiring Lc, respectively. The temperature-detecting circuit 1 includes an electrostatic protection circuit 12 for protecting the temperature-detecting element 11.

The electrostatic protection circuit 12 includes a transistor Tr connected between the first wiring La and the second wiring Lc. The transistor Tr is electrically connected in parallel to the temperature-detecting element 11. One of the source/drain of the transistor Tr is electrically connected to the first wiring La between the first terminal 102a and the temperature detection element 11. The other of the source/drain of the transistor Tr is electrically connected to the second wiring Lc between the second terminal 102c and the temperature-detecting element 11. In the present embodiment, similar to the pixel transistors 30, the transistor Tr is formed of an N-channel type thin film transistor.

The electrostatic protection circuit 12 includes a first capacitance element C1 and a second capacitance element C2 electrically connected in series to each other between the first wiring La and the second wiring Lc. More specifically, one end of the first capacitance element C1 is electrically connected to the first wiring La, one end of the second capacitance element C2 is electrically connected to the second wiring Lc, and the other end of the first capacitance element C1 and the other end of the second capacitance element C2 are electrically connected to each other.

In the electrostatic protection circuit 12, the connecting node Cn between the first capacitance element C1 and the second capacitance element C2 is electrically connected to the gate of the transistor Tr. The electrostatic protection circuit 12 includes a third resistor unit R3 electrically connected in parallel to the first capacitance element C1. More specifically, gate wiring Lg extending from the gate of the transistor Tr is electrically connected to the connecting node Cn between the first capacitance element C1 and the second capacitance element C2, and is electrically connected to the second wiring Lc via the third resistor unit R3.

In the temperature-detecting circuit 1, the first resistor unit R1 is inserted into the first wiring La between the first terminal 102a and the connecting position between the first wiring La and the first capacitance element C1, and the second resistor unit R2 is inserted into the second wiring Lc between the second terminal 102c and the connecting position between the second wiring Lc and the second capacitance element C2.

In the present embodiment, the size or the like of the circuit elements used in the temperature-detecting circuit 1 is as follows, for example. However, these are not limited to the following conditions.

Transistor Tr has a channel width W of 800 μm, and a channel length L of 5 μm.

The first capacitance element C1 has a capacitance of 5 pF.

The second capacitance element C2 has a capacitance of 5 pF.

The first resistor unit R1 has a resistance value of 10 kΩ.

The second resistor unit R2 has a resistance value of 10 kΩ.

The third resistor unit R3 has a resistance value of 500 kΩ.

In the electro-optical device 100 configured in this way, when a surge current caused by static electricity invades from the first terminal 102a, the electrostatic protection circuit 12 protects the temperature-detecting element 11 from static electricity. More specifically, in the electrostatic protection circuit 12, the gate-source voltage of the transistor Tr is 0 V and the transistor Tr is off in a static state. In contrast, when a surge current caused by static electricity invades from the first terminal 102a, the potential of the gate of the transistor Tr, which is the potential of the connecting node Cn between the first capacitance element C1 and the second capacitance element C2, rises while voltage fluctuation is suppressed by the first resistor unit R1. This brings the transistor Tr into the ON state, and thus the surge current flows to the second terminal 102c via the transistor Tr and the second wiring Lc. At this time, the first resistor unit R1 mitigates the surge current invading from the first terminal 102a, and the second resistor unit R2 mitigates the surge current invading from the second terminal 102c. Furthermore, the period in which the transistor Tr is turned on is determined by the first capacitance element C1, the second capacitance element C2, the third resistor unit R3, the gate capacitance of and the transistor Tr, and the like. After discharging, the potential of the gate of the transistor Tr is returned to the OFF potential by the third resistor unit R3. Thus, the surge current flowing through the temperature-detecting element 11 is suppressed by the electrostatic protection circuit 12, and thus the temperature-detecting element 11 can be protected. Note that the first resistor unit R1 and the second resistor unit R2 cause a voltage drop of the temperature-detecting element 11 due to the driving current It. However, the driving current It is extremely small, and thus the impact of the voltage drop due to the first resistor unit R1 and the second resistor unit R2 is almost negligible.

### 1-4. Layout and the Like of Temperature-Detecting Circuit 1 and the Like

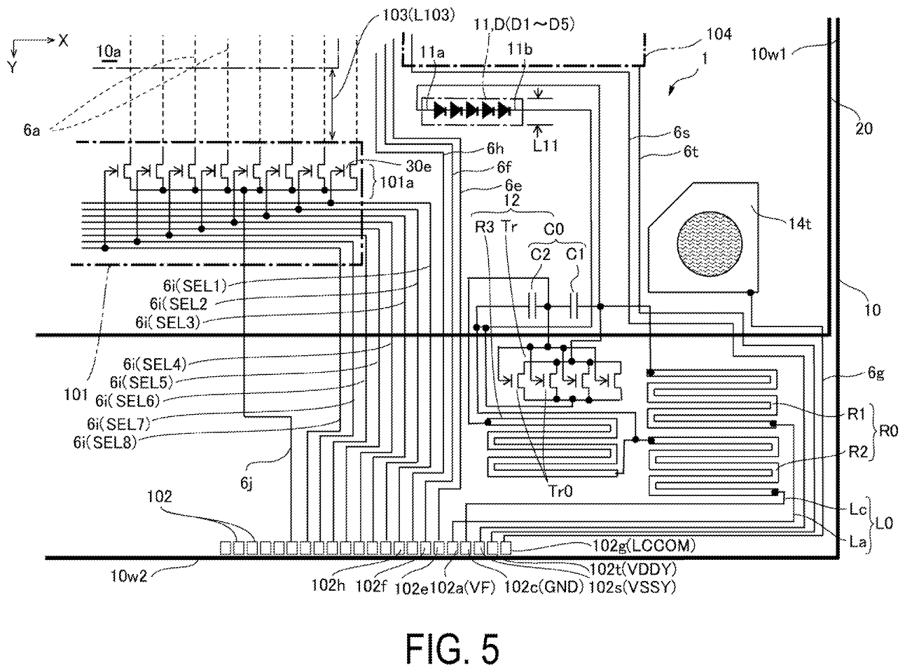

FIG. 5 is an explanatory view illustrating a planar configuration of the temperature-detecting circuit 1 and the like illustrated in FIG. 4. Note that FIG. 5 illustrates a case in which five diodes D are electrically connected in series to each other in the temperature-detecting element 11. As illustrated in FIG. 5, the first substrate 10 includes the scanning line driving circuit 104 disposed along the first direction Y between the display region 10a and the first side 10w1. The inter-substrate conduction electrode 14t for establishing conduction between the first substrate 10 and the second substrate 20 is provided between the scanning line driving circuit 104 and the second side 10w2.

Furthermore, the first substrate 10 includes the data line driving circuit 101 disposed along the second direction X between the display region 10a and the second side 10w2. The plurality of data lines 6a extend in the first direction Y from the data line driving circuit 101, and are electrically connected to the pixel circuits 100a of the display region 10a described above with reference to FIG. 3. Accordingly, the space between the data line driving circuit 101 and the display region 10a represents a wiring region 103 in which the plurality of data lines 6a extend from the data line driving circuit 101 to the display region 10a.

In the present embodiment, a selection circuit 101a that constitutes a demultiplexer is provided at an end portion closest to the display region 10a of the data line driving circuit 101. The data lines 6a extend along the first direction Y from the selection circuit 101a toward the display region 10a. The selection circuit 101a includes transistors 30e that control electrical connecting between the data lines 6a and image signal wiring 6j. In the present embodiment, the demultiplexer includes, for example, eight selection circuits 101a. In such a data line driving circuit 101, the image signal VID is supplied from the driving IC 75 illustrated in FIG. 3 via a terminal 102 and the image signal wiring 6j. At this time, the transistors 30e of the selection circuit 101a supply the image signal VID to each of the data lines 6a in a time division manner based on selection signals SEL1, SEL2, . . . , and SEL8 supplied from the driving IC 75 via control signal wiring 6i.

The temperature-detecting element 11 is provided in the first direction Y relative to the scanning line driving circuit 104. More specifically, the temperature-detecting element 11 is disposed so as to be adjacent to the scanning line driving circuit 104 in the first direction Y between the scanning line driving circuit 104 and the second side 10w2. Furthermore, the temperature-detecting element 11 is arranged so as to be adjacent to the data line driving circuit 101 or the wiring region 103 in the second direction X. In the present embodiment, the temperature-detecting element 11 is disposed so as to be adjacent to the wiring region 103 in the direction along the second direction X on the first side 10w1 side. Here, the plurality of diodes D constituting the temperature-detecting element 11 are arranged in a constant direction. In the present embodiment, the plurality of diodes D constituting the temperature-detecting element 11 are arranged in the second direction X. Accordingly, the dimension L11 in the first direction Y of the temperature-detecting element 11 is smaller than the dimension L103 in the first direction Y of the wiring region 103.

In the present embodiment, as will be described below, the first wiring La and the second wiring Lc are collectively drawn around as the wiring line LO electrically connected to the electrostatic protection circuit 12. The first resistor unit R1 and the second resistor unit R2 are collectively disposed as a resistor unit R0 electrically connected to the wiring LO. Note that in electrically connecting the first wiring La to the first terminal 102a and electrically connecting the second wiring Lc to the second terminal 102c, a multilayer wiring structure is utilized to cause the first wiring La and the second wiring Lc to intersect each other while ensuring insulation.

The entire electrostatic protection circuit 12 is collectively disposed. Accordingly, the first capacitance element C1 and the second capacitance element C2 are collectively disposed as a capacitance element C0 of the electrostatic protection circuit 12. The capacitance element C0, the transistor Tr, and the third resistor unit R3 are collectively disposed.

More specifically, the electrostatic protection circuit 12 is collectively disposed between an inter-substrate conduction electrode 14t and the second side 10w2. In the present embodiment, when viewed from a direction along the first direction Y, the electrostatic protection circuit 12 is disposed at a position displaced from the inter-substrate conduction electrode 14t to a side opposite to the first side 10w1 in the direction along the second direction X. When viewed from the direction along the second direction X, the electrostatic protection circuit 12 is provided between the inter-substrate conduction electrode 14t and the second side 10w2. In the present embodiment, the capacitance element C0 (the first capacitance element C1 and the second capacitance element C2), the transistor Tr, and the third resistor unit R3 that constitute the electrostatic protection circuit 12 are disposed so as to be aligned in this order from the inter-substrate conduction electrode 14t side toward the second side 10w2 side.

Furthermore, in the capacitance element C0, the first capacitance element C1 and the second capacitance element C2 are disposed so as to be aligned in the direction along the second direction X. In the present embodiment, the first capacitance element C1 is disposed on the first side 10w1 side relative to the second capacitance element C2.

In the transistor Tr, an integrally formed semiconductor layer is utilized to form a plurality of unit transistor elements Tr0. The plurality of unit transistor elements Tr0 are electrically connected in parallel to each other to form the transistor Tr. Note that FIG. 5 illustrates an aspect in which the plurality of unit transistor elements Tr0, which are four in total, are electrically connected in parallel to each other. However, the number of unit transistor elements Tr0 electrically connected in parallel to each other is not limited to four.

In the wiring LO electrically connected to the electrostatic protection circuit 12, the resistor unit R0 is also provided between the inter-substrate conduction electrode 14t and the second side 10w2. More specifically, the resistor unit R0 is disposed between the electrostatic protection circuit 12 and the first side 10w1. In the present embodiment, the wiring LO includes the first wiring La and the second wiring Lc electrically connected to the temperature-detecting element 11. The resistor unit R0 includes the first resistor unit R1 electrically connected to the first wiring La, and the second resistor unit R2 electrically connected to the second wiring Lc. The first resistor unit R1 and the second resistor unit R2 are disposed so as to be aligned in the first direction Y between the electrostatic protection circuit 12 and the first side 10w1. In the present embodiment, the first resistor unit R1 is disposed on the inter-substrate conduction electrode 14t side of the second resistor unit R2.

In the electro-optical device 100 configured in this way, the first substrate 10 includes first constant potential wiring 6h extending in the first direction Y at a position adjacent to the temperature-detecting element 11 on the side opposite to the first side 10w1. The first constant potential wiring 6h is, for example, constant potential wiring for supplying the common potential LCCOM to the dummy pixel electrodes 9b illustrated in FIG. 2. The first substrate 10 includes inspection wiring 6e and 6f that extend in the first direction Y between the first constant potential wiring 6h and the temperature-detecting element 11 and that reach the inspection circuit 105. In the present embodiment, the first constant potential wiring 6h extends in the second direction X between the data line driving circuit 101 and the electrostatic protection circuit 12, and between the wiring region 103 and the temperature-detecting element 11.

The first substrate 10 includes second constant potential wiring 6s extending in the second direction X between the temperature-detecting element 11 and the scanning line driving circuit 104. The second constant potential wiring 6s is constant potential wiring for supplying the low level constant potential VSSY to the scanning line driving circuit 104. After passing between the first resistor unit R1 and the first side 10w1 from the terminal 102s, the second constant potential wiring 6s extends in the second direction X between the temperature-detecting element 11 and the scanning line driving circuit 104, and further extends in the first direction Y toward the scanning line driving circuit 104.

Note that constant potential wiring 6t that supplies the high level constant potential VDDY to the scanning line driving circuit 104 and common potential wiring 6g that supplies the constant potential LCCOM to the inter-substrate conduction electrode 14t are provided on the first side 10w1 side of the second constant potential wiring 6s. The common potential wiring 6g is electrically connected to the capacitance lines 8a by the multilayer wiring structure. Capacitance lines 8a are also used outside the display region 10a as wiring having a relatively wide width to block light or as a shield.

### 1-5. Configuration Example of Temperature-Detecting Element 11

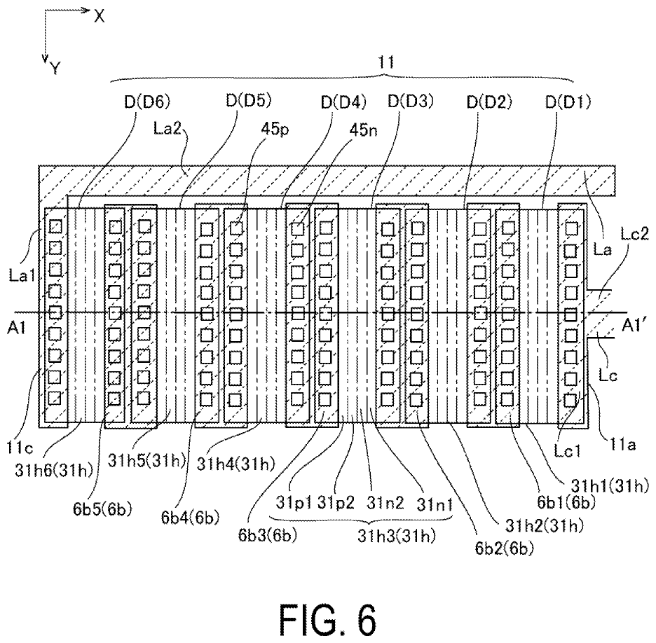

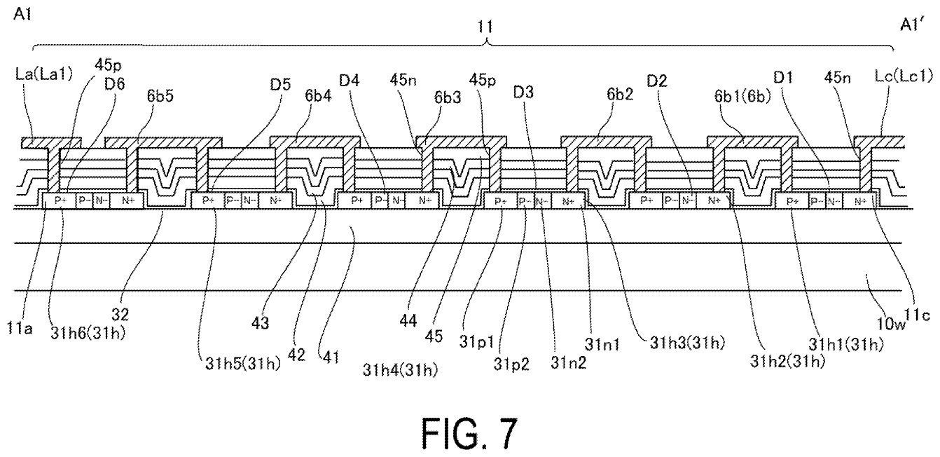

FIG. 6 is a plan view schematically illustrating a planar configuration of the temperature-detecting element 11 illustrated in FIG. 5. FIG. 7 is a cross-sectional view schematically illustrating a cross section of the temperature-detecting element 11 illustrated in FIG. 6. FIG. 7 corresponds to a cross section taken along the line A1-A1′ in FIG. 6. FIGS. 6 and 7 illustrate a case in which six diodes D are electrically connected in series to each other in the temperature-detecting element 11. Note that in FIGS. 6 and 7, of the N-type regions and the P-type regions provided at a semiconductor layer 31h that constitute the temperature-detecting element 11, one corresponds to first impurity regions of a first conductivity type, and the other corresponds to second impurity regions of a second conductivity type. In the present embodiment, of the N-type regions and the P-type regions provided in the semiconductor layer 31h, the N-type regions correspond to the first impurity regions, and the P-type regions correspond to the second impurity regions. Furthermore, in FIG. 7, illustration of a layer or the like on the upper layer side of the temperature-detecting element 11 formed in the first substrate 10 is omitted to the extent that such omission does not affect the description.

In the present embodiment, in forming the temperature-detecting element 11 illustrated in FIG. 5, a plurality of semiconductor layers 31h separated from each other in an island shape are arranged in a constant direction as illustrated in FIGS. 6 and 7. The plurality of semiconductor layers 31h are used to form diodes D. In the present embodiment, six semiconductor layers 31h1 to 31h6 are arranged in the second direction X as a constant direction, and the six semiconductor layers 31h are used to form six diodes D. More specifically, in each of the six semiconductor layers 31h, N-type regions and P-type regions are disposed aligned in the second direction X. In the present embodiment, the N-type regions include high concentration N-type regions 31n1 and low concentration N-type regions 31n2, and the P-type regions include high concentration P-type regions 31p1 and low concentration P-type regions 31p2. The connecting portion between a low concentration N-type region 31n2 and a low concentration P-type region 31p2 constitutes a PN junction surface. Note that the configuration of the junction surface is not limited to this configuration.

Relay electrodes 6b that electrically connect the diodes D are formed in an upper layer of an insulating film 45. In the present embodiment, the five relay electrodes 6b1 to 6b5 are each electrically connected to a high concentration P-type region 31p1 of a semiconductor layer 31h and a high concentration N-type region 31n1 of an adjacent semiconductor layer 31h via contact holes 45p and 45n that penetrate a gate insulating film 32 and insulating films 42, 43, 44, and 45. Furthermore, of the semiconductor layers 31h, the two semiconductor layers 31h located at both ends are electrically connected to the first wiring La and the second wiring Lc, respectively, via the contact holes 45p and 45n that penetrate the gate insulating film 32 and the insulating films 42, 43, 44, and 45.

In the present embodiment, the first wiring La includes a first connecting portion La1 extending in the first direction Y, and a first extending portion La2 extending in the second direction X from an end portion of the first connecting portion La1. The first connecting portion La1 is electrically connected to one electrode of the temperature-detecting element 11. The second wiring Lc includes a second connecting portion Lc1 extending in the first direction Y, and a second extending portion Lc2 extending in the second direction X from the second connecting portion Lc1. The second connecting portion Lc1 is electrically connected to the other electrode of the temperature-detecting element 11. In the present embodiment, one electrode of the temperature-detecting element 11 is the anode 11a, and the other electrode of the temperature-detecting element 11 is the cathode 11c.

The first wiring La, the second wiring Lc, and the relay electrodes 6b are wiring formed in the same layer as the data lines 6a, as are the first constant potential wiring 6h, the second constant potential wiring 6s, the constant potential wiring 6i, the common potential wiring 6g, the control signal wiring 6i, and the image signal wiring 6j illustrated in FIG. 5. The first wiring La, the second wiring Lc, and the relay electrodes 6b are low resistance wiring mainly composed of aluminum.

In the temperature-detecting element 11, the plurality of semiconductor layers 31h include N-type regions and P-type regions between, of the plurality of relay electrodes 6b, a relay electrode 6b adjacent to the first connecting portion La1 and the first connecting portion La1, and include N-type regions and P-type regions between, of the plurality of relay electrodes 6b, a relay electrode 6b adjacent to the second connecting portion Lc1 and the second connecting portion Lc1. Furthermore, the plurality of semiconductor layers 31h include N-type regions and P-type regions between, of the plurality of relay electrodes 6b, two relay electrodes 6b adjacent to each other. That is, the relay electrodes 6b have a narrow width in the second direction X. Accordingly, the parasitic capacitance between the relay electrodes 6b and a noise source is small.

### 1-5. Another Configuration Example of Temperature-Detecting Element 11

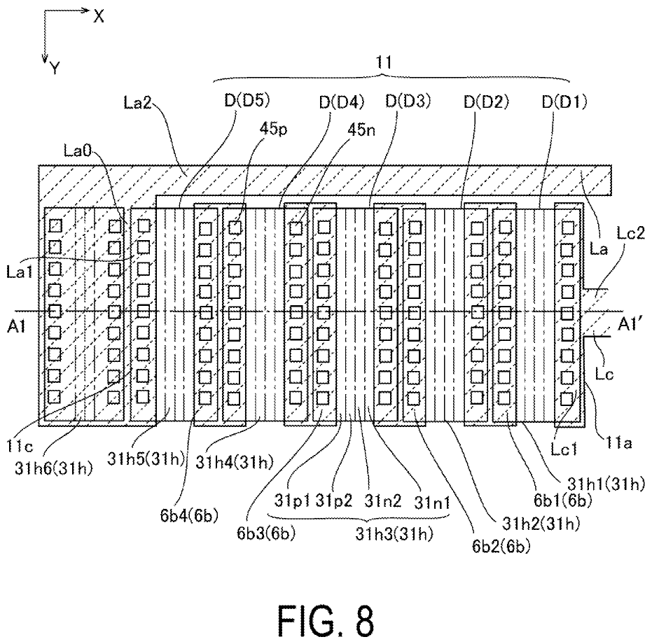

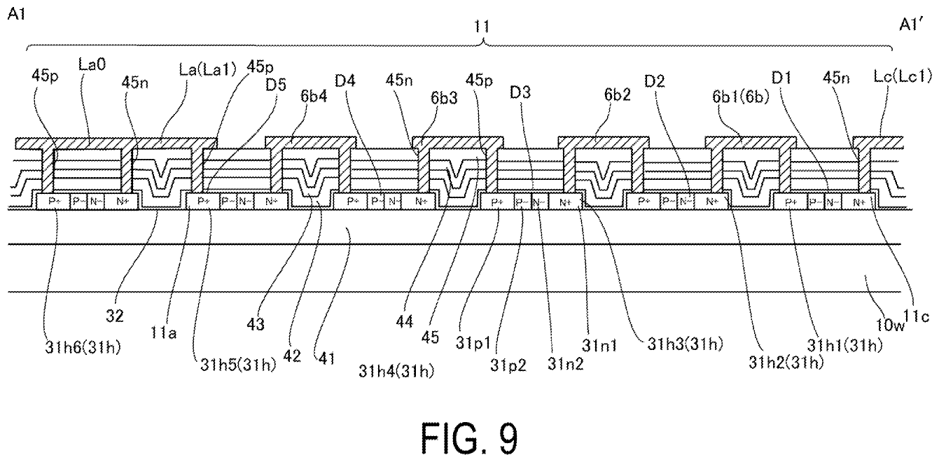

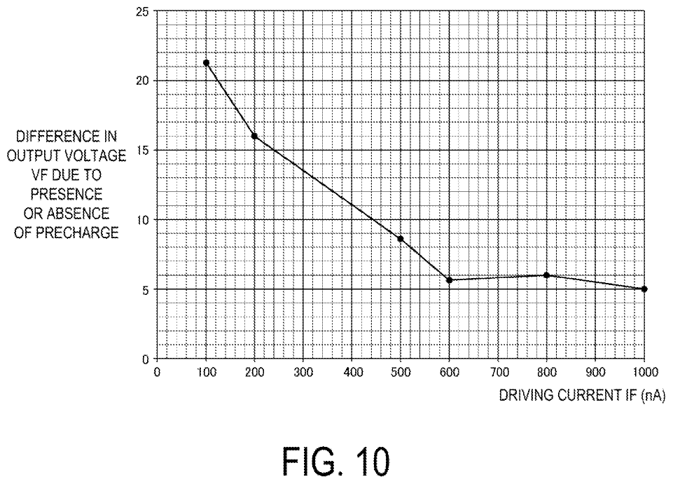

FIG. 8 is a plan view schematically illustrating another planar configuration of the temperature-detecting element 11 illustrated in FIG. 5. FIG. 9 is a cross-sectional view schematically illustrating a cross section of the temperature-detecting element 11 illustrated in FIG. 8. FIG. 9 corresponds to a cross section taken along the line A1-A1′ in FIG. 8. In FIGS. 8 and 9, for reasons to be described later with reference to FIG. 10, the six semiconductor layers 31h illustrated in FIGS. 6 and 7 are used as is, and only the formation range of the first connecting portion La1 of the first wiring La is modified. In this way, the temperature-detecting element 11 in which six diodes D are electrically connected in series to each other (see FIGS. 6 and 7) are modified into a temperature-detecting element 11 in which five diodes D are electrically connected in series to each other.

More specifically, as illustrated in FIGS. 8 and 9, the formation range of the first connecting portion La1 of the first wiring La is expanded in the second direction X to form a short-circuit portion La0 that electrically short-circuits the N-type region and the P-type regions of the semiconductor layers 31h6 overlapping the first connecting portion La1 in plan view. As a result, the temperature-detecting element 11 in which six diodes D are electrically connected in series to each other (see FIGS. 6 and 7) can be modified into a temperature-detecting element 11 in which five diodes D are electrically connected in series to each other. Therefore, a temperature-detecting element 11 in which an appropriate number of diodes D are electrically connected in series to each other can be easily formed. The other configurations are the same as those in FIGS. 6 and 7, and thus description thereof is omitted.

Note that in the present embodiment, the first connecting portion La1 of the first wiring La is expanded in the second direction X to reduce the number of diodes D electrically connected in series to each other in the temperature-detecting element 11. However, the number of diodes D electrically connected in series to each other in the temperature-detecting element 11 may be reduced by expanding the second connecting portion Lc1 of the second wiring Lc, and providing a short-circuit portion that electrically short-circuits the N-type regions and the P-type region of the semiconductor layers 31h6 overlapping the second connecting portion Lc1 in plan view.

Furthermore, the number of diodes D electrically connected in series to each other in the temperature-detecting element 11 may be reduced by expanding a relay electrode 6b in the second direction X, and providing a short-circuit portion that electrically short-circuits the N-type region or regions and the P-type region or regions of the semiconductor layers 31h6 overlapping the relay electrode 6b in plan view.

However, in the temperature-detecting element 11 in which the plurality of diodes D are electrically connected in series to each other, the parasitic capacitance between the relay electrodes 6b and a noise source has a greater impact on the output voltage VF from the temperature-detecting element 11 than the parasitic capacitance between the first wiring La and the noise source and the parasitic capacitance between the second wiring Lc and the noise source. Accordingly, the configuration in which the first connecting portion La1 of the first wiring La is expanded and the configuration in which the second connecting portion Lc1 of the second wiring Lc is expanded have the advantage that the impact of noise is smaller than that in the configuration in which a relay electrode 6b is expanded.

### 1-6. Number of Diodes D in Temperature-Detecting Element 11

FIG. 10 is a graph showing an example of the relationship between the driving current IF and the impact of noise. FIG. 10 shows the change in the output voltage VF (ΔVF) of the temperature-detecting element 11 with the magnitude of the driving current IF and the presence or absence of precharge in the electro-optical device 100.

In electrically connecting the capacitance lines 8a illustrated in FIG. 3 to the common potential wiring 6g, when capacitance lines 8a are caused to extend to the outside of the display region 10a as wiring having a relatively wide width and are used to block light or as shields, a parasitic capacitance is formed between such capacitance lines 8a and the temperature-detecting element 11. Here, the capacitance lines 8a overlap the data lines 6a in plan view, and thus a large parasitic capacitance is formed between the capacitance lines 8a and the data lines 6a. Accordingly, while the common potential LCCOM is applied to the capacitance lines 8a, noise is caused in the capacitance lines 8a by the change in voltage of the data lines 6a that occurs when precharge is performed. As a result, the noise of the capacitance lines 8a affects the output voltage VF from the temperature-detecting element 11 via the parasitic capacitance between the capacitance lines 8a and the relay electrodes 6b of the temperature-detecting element 11, causing the output voltage VF to fluctuate.

As shown in FIG. 10, the impact of such noise tends to be mitigated by increasing the driving current IF. For example, in the example shown in FIG. 10, increasing the driving current IF to 600 nA can mitigate the impact of noise. However, increasing the driving current IF raises the output voltage VF from the temperature-detecting element 11, and thus causes problems such as increased burden in the temperature detection driving circuit 66 illustrated in FIG. 3. Furthermore, the output voltage VF from the temperature-detecting element 11 is higher when six diodes D are electrically connected in series to each other in the temperature-detecting element 11 than when five diodes D are electrically connected in series to each other therein. Therefore, for the temperature-detecting element 11, a configuration in which five diodes D are electrically connected in series to each other may be used rather than a configuration in which six diodes D are electrically connected in series to each other. On the other hand, the greater the number of diodes D electrically connected in series to each other, the better the sensitivity.

In view of such a situation, in the present embodiment, as described with reference to FIGS. 6, 7, 8, and 9, appropriately setting the width in the second direction X of the first connecting portion La1 of the first wiring La without modifying the basic configuration of the temperature-detecting element 11 can easily realize a temperature-detecting element 11 in which six diodes D are electrically connected in series to each other and a temperature-detecting element 11 in which five diodes D are electrically connected in series to each other. Thus, a temperature-detecting element 11 in which an appropriate number of diodes D are electrically connected in series to each other can be used in the electro-optical device 100.

### 1-7. Main Advantageous Effects of Present Embodiment

As described above, in the electro-optical device 100 of the present embodiment, the temperature-detecting element 11 is disposed so as to be adjacent to the scanning line driving circuit 104 between the scanning line driving circuit 104 and the second side 10w2, and thus the temperature-detecting element 11 can be disposed near the display region 10a. Accordingly, the temperature of the electro-optical layer 50 of the display region 10a can be appropriately detected. Furthermore, the temperature-detecting element 11 and wiring LO (the first wiring La and the second wiring Lc) electrically connected to the temperature-detecting element 11 can be separated from the scanning lines 3a, and thus the impact of noise from the scanning lines 3a on the wiring LO can be reduced. Therefore, the temperature-detecting element 11 has high detection accuracy.

Furthermore, the electrostatic protection circuit 12 is disposed between the inter-substrate conduction electrode 14t and the second side. In the wiring line LO, the resistor unit R0 is disposed between the electrostatic protection circuit 12 and the first side 10w1. Accordingly, the resistor unit R0 can be disposed, of the space that separates the resistor unit R0 from the terminals 102, in a free space near the first side 10w1, and thus the presence of the resistor unit R0 does not affect the layout of the wiring much. Therefore, it is possible to prevent increase in size of the electro-optical device 100.

Furthermore, the first resistor unit R1 and the second resistor unit R2 of the resistor unit R0 are disposed aligned along the first direction Y between the inter-substrate conduction electrode 14t and the second side 10w2 in the space between the electrostatic protection circuit 12 and the first side 10w1. Accordingly, the resistor unit R0 can be disposed in a narrow range in the second direction X. Therefore, the presence of the resistor unit R0 does not affect the layout of the wiring much.

Furthermore, the transistor Tr, the capacitance element C0, and the third resistor unit R3 that constitute the electrostatic protection circuit 12 are disposed aligned along the first direction Y between the inter-substrate conduction electrode 14t and the second side 10w2. Accordingly, the electrostatic protection circuit 12 can be disposed within a narrow range in the second direction X. Therefore, the presence of the electrostatic protection circuit 12 does not affect the layout of the wiring much.

Further, the temperature-detecting element 11 is susceptible to noise since a plurality of diodes D are electrically connected in series to each other therein. However, the first potential wiring 6h and the second constant potential wiring 6s extend in the vicinity of the temperature-detecting element 11. Accordingly, the first constant potential wiring 6h and the second constant potential wiring 6s can be utilized as shields, and thus the temperature-detecting element 11 is less susceptible to noise from signal lines such as data lines 6a and the like.

Furthermore, the temperature-detecting element 11 includes a plurality of semiconductor layers 31h provided aligned in a constant direction, and thus it is relatively easy to electrically connect a plurality of diodes D in series to each other in the temperature-detecting element 11. Furthermore, the plurality of semiconductor layers 31h are arranged so as to be aligned in the second direction X, and thus even when the number of diodes D electrically connected in series to each other is to be increased, space constraints are not likely to be an issue. Furthermore, the plurality of semiconductor layers 31h are arranged so as to be aligned in the second direction X, and thus the dimension L11 in the first direction Y of the temperature-detecting element 11 can be smaller than the dimension L103 in the first direction Y of the wiring region 103. Therefore, the entire temperature-detecting element 11 can be disposed near the display region 10a.

### 2. Embodiment 2

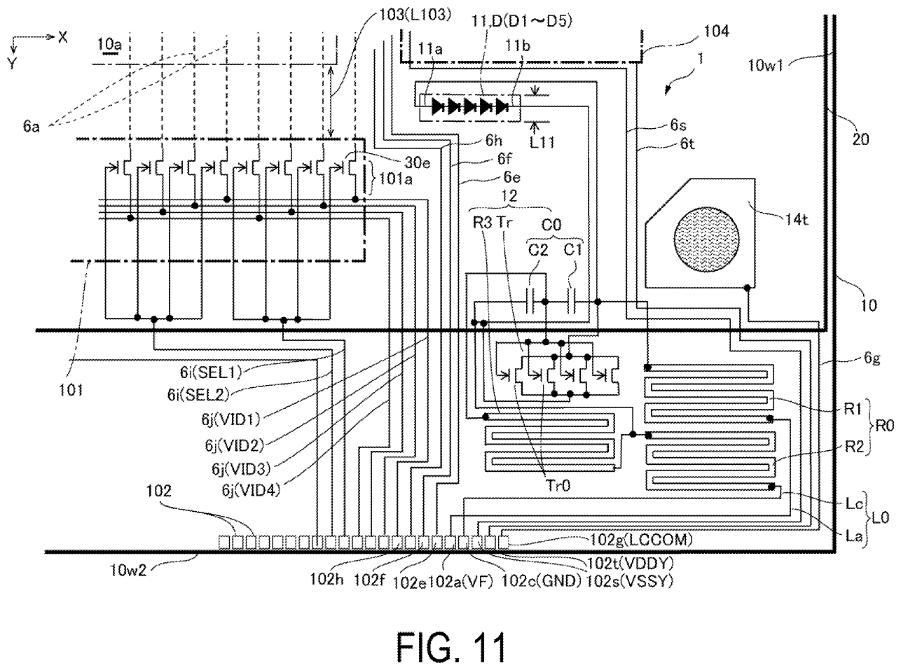

FIG. 11 is an explanatory view of the electro-optical device 100 according to Embodiment 2 of the present disclosure. Note that the basic configuration of the present embodiment is similar to that of Embodiment 1. Thus, the common components are denoted by the same reference signs, with description thereof being omitted. In Embodiment 1, in the data line driving circuit 101, the control signal wiring 6i extending in the second direction X is disposed in parallel with each other in the first direction Y. However, as illustrated in FIG. 11, the present disclosure may be applied to an electro-optical device 100 in which the image signal wiring 6j extending in the second direction X is disposed in parallel with each other in the first direction Y.

### 3. Other Embodiments of Electro-Optical Device

In the present disclosure, the electro-optical device 100 is not limited to liquid crystal devices. The present disclosure may be applied to electro-optical devices 100 other than liquid crystal devices, such as organic electroluminescence devices.

### 4. Configuration Example of Electronic Apparatus

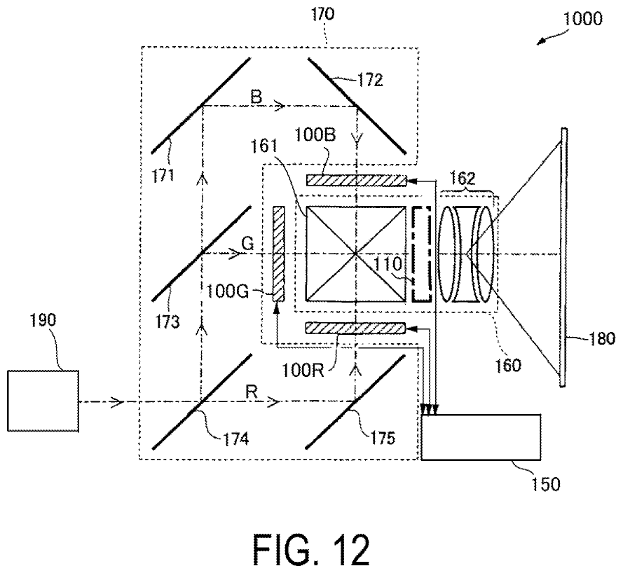

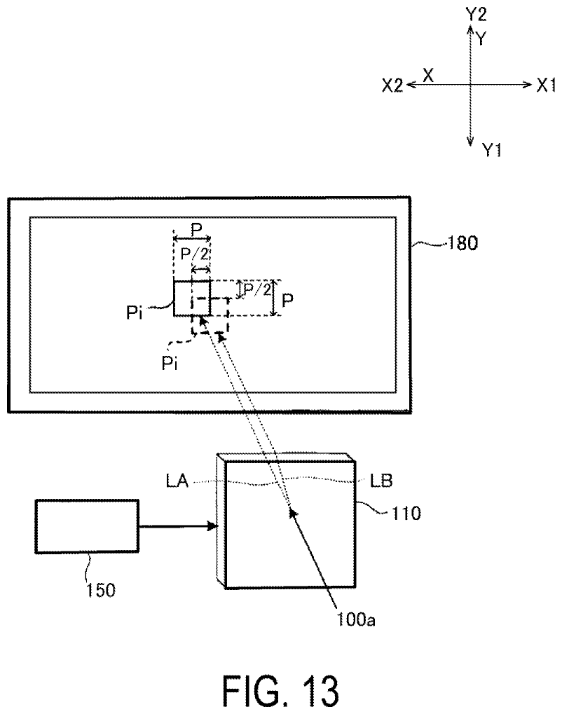

FIG. 12 is a block diagram illustrating a configuration example of a projection-type display device 1000 to which the present disclosure is applied. FIG. 13 is an explanatory view of an optical path-shifting element 110 illustrated in FIG. 12. Note that in FIG. 12, illustration of polarizing plates and the like is omitted. The projection-type display device 1000 illustrated in FIG. 12 is an example of an electronic apparatus to which the present disclosure is applied. The projection-type display device 1000 includes an illumination device 190, a separation optical system 170, three electro-optical devices 100R, 100G, and 100B, and a projection optical system 160. The electro-optical devices 100R, 100G, and 100B each includes an electro-optical device 100 described above with reference to FIGS. 1 to 11.

The illumination device 190 is a white light source, and a laser light source or a halogen lamp is used therefor, for example. The separation optical system 170 includes three mirrors 171, 172, and 175, as well as dichroic mirrors 173 and 174. The separation optical system 170 separates white light emitted from the illumination device 190 into three primary colors of red (R), green (G), and blue (B). Specifically, the dichroic mirror 174 transmits light of the wavelength region of red (R), and reflects light of the wavelength regions of green (G) and blue (B). The dichroic mirror 173 transmits light of the wavelength region of blue (B), and reflects light of the wavelength region of green (G). Light corresponding to red (R), green (G), and blue (B) is guided to the electro-optical devices 100R, 100G, and 100B, respectively.

Light modulated by the electro-optical devices 100R, 100G, and 100B is incident on a dichroic prism 161 from three directions. The dichroic prism 161 constitutes a synthesis optical system in which images of red (R), green (G), and blue (B) are synthesized. Accordingly, a projection lens system 162 can magnify and project a synthesized image emitted from the optical path-shifting element 110 to a projection member such as a screen 180 to display a color image on the projection member such as the screen 180.

At this time, a control unit 150 can correct image signals supplied to the electro-optical devices 100R, 100G, and 100B based on temperature detection results of the temperature-detecting circuit 1. Therefore, even when the environmental temperature or the like fluctuates, a high quality projection image can be displayed. Furthermore, when a configuration is employed in which a technology of providing the optical path-shifting element 110 indicated by a dot-dash line in the projection optical system 160 on the light emission side of the dichroic prism 161 and shifting the position at which a projected pixel is visually recognized every predetermined period is used to enhance resolution, it becomes necessary to drive the liquid crystal layer at high speed. Even in this case, employing a configuration in which image signals supplied to the electro-optical devices 100R, 100G, and 100B are corrected based on temperature detection results of the temperature-detecting circuit 1 or a configuration in which the temperature of the electro-optical panels 100p of the electro-optical devices 100R, 100G, and 100B is adjusted based on temperature detection results of the temperature-detecting circuit 1 can drive the electro-optical layer 50 including a liquid crystal layer at high speed.

As illustrated in FIG. 13, the optical path-shifting element 110 is an optical element that shifts the light emitted from the dichroic prism 161 in a preset direction. FIG. 13 illustrates a state in which the position of a projected pixel Pi, at which the light emitted from each of the pixel circuits 100a of the electro-optical panel 100p is visually recognized, is shifted to one side X1 in the X direction by a distance corresponding to 0.5 pixel pitch (which is equal to P/2), and to one side Y1 in the Y direction by a distance corresponding to 0.5 pixel pitch (which is equal to P/2) by the optical path-shifting element 110. The optical path-shifting element 110 includes a light-transmitting plate. Under the command of the control unit 150, an actuator causes the light-transmitting plate to swing about one or both of an axial line extending in the first direction Y or an axial line extending in the second direction X, thereby shifting the optical path of the light emitted from each of the pixel circuits 100a of the electro-optical panel 100p to an optical path LA and an optical path LB.

### 5. Other Embodiments of Electronic Apparatus

A projection-type display apparatus may be configured to use an LED light source or the like that emits light of various colors as a light source unit, and supply each colored light emitted from such an LED light source to another liquid crystal device.

Electronic apparatuses including the electro-optical device 100 to which the present disclosure is applied are not limited to the projection-type display device 1000 of the above-described embodiment. For example, the electro-optical device 100 to which the present disclosure is applied may be used in electronic apparatuses such as a headup display (HUD), a head-mounted display (HMD), a personal computer, a digital still camera, and a liquid crystal television.

What is claimed is:

1. An electro-optical device comprising:
a scanning line driving circuit disposed along a first direction; and
a temperature-detecting element disposed in the first direction relative to the scanning line driving circuit; wherein
the temperature-detecting element includes a plurality of semiconductor layers provided aligned in a constant direction.

2. The electro-optical device according to claim 1, wherein the constant direction is a second direction intersecting the first direction.

3. The electro-optical device according to claim 2, wherein a plurality of data lines extending in the first direction are arranged along the second direction.

4. The electro-optical device according to claim 3, wherein
the plurality of semiconductor layers each includes a first impurity region of a first conductivity type and a second impurity region of a second conductivity type and
the first impurity region of the first conductivity type and the second impurity region of the second conductivity type are disposed aligned along the second direction.

5. The electro-optical device according to claim 4, wherein
a first wiring and a second wiring are electrically connected to the temperature-detecting element,
the first wiring includes a first connecting portion that extends in the first direction and that is electrically connected to one electrode of the temperature-detecting element,
the second wiring includes a second connecting portion that extends in the first direction and that is electrically connected to the other electrode of the temperature-detecting element,
the temperature-detecting element includes, between the first connecting portion and the second connecting portion, a plurality of relay electrodes that electrically connect the first impurity region of one semiconductor layer and the second impurity region of another semiconductor layer to each other, the one semiconductor layer and the other semiconductor layer being adjacent to each other in the second direction among the plurality of semiconductor layers, and
the plurality of semiconductor layers include the first impurity region and the second impurity region
between a relay electrode, of the plurality of relay electrodes, adjacent to the first connecting portion and the first connecting portion,
between two relay electrodes adjacent to each other of the plurality of relay electrodes, and
between a relay electrode, of the plurality of relay electrodes, adjacent to the second connecting portion and the second connecting portion, respectively.

6. The electro-optical device according to claim 5, wherein at least one of the first connecting portion, the relay electrodes, and the second connecting portion includes a short-circuit portion that electrically short-circuits a first impurity region and a second impurity region provided at, of the plurality of semiconductor layers, a semiconductor layer overlapping the at least one of the first connecting portion, the relay electrodes, and the second connecting portion in plan view.

7. The electro-optical device according to claim 3, further comprising a data line driving circuit disposed along the second direction and
a wiring region in which the plurality of data lines extend between the data line driving circuit and a display region, wherein
the temperature-detecting element is disposed so as to be adjacent to the data line driving circuit or the wiring region in the second direction.

8. The electro-optical device according to claim 7, wherein
the temperature-detecting element is disposed so as to be adjacent to the wiring region in the second direction and
a dimension in the first direction of the temperature-detecting element is smaller than a dimension in the first direction of the wiring region.

9. The electro-optical device according to claim 7, further comprising a first constant potential wiring extending in the first direction between the temperature-detecting element and the wiring region.

10. The electro-optical device according to claim 9, further comprising an inspection wiring extending in the first direction between the first constant potential wiring and the temperature-detecting element.

11. The electro-optical device according to claim 3, further comprising second constant potential wiring extending in the second direction between the scanning line driving circuit and the temperature-detecting element.

12. An electronic apparatus comprising the electro-optical device according to claim 1.
